(19) United States
(12) Patent Application Publication
(10) Pub. No.: US 2006/0253333 A1
(43) Pub. Date: Nov. 9, 2006

(54) Centralized distributions

(75) Inventors: Kevin Michael Magarian, Fargo, ND (US); Kristi Marie Weekley, Lake Park, MN (US); Ronald H. Schulz, West Fargo, ND (US); Steven Todd Degele, Fargo, ND (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/094,895

(22) Filed: Mar. 31, 2005

(51) Int. Cl. G07G 1/12

(52) U.S. Cl. 705/24

(57) ABSTRACT

A computer-based accounting system has sub-ledgers, a general ledger and centralized distributions. The sub-ledgers are adapted to record transaction information. The general ledger is adapted to record transaction information from general ledger transactions and information representative of the transaction information from each of the sub-ledgers. The centralized distributions is a repository of distribution lines corresponding to the transaction information contained in the general ledger and the sub-ledgers. The centralized distributions is adapted to associate each distribution line with an originating transaction, allowing the originating transaction to maintain control of its distribution lines.

### BACKGROUND OF THE INVENTION

The present invention relates to computerized accounting systems, and more particularly, to systems and methods for maintaining consistent financial distributions between various ledgers of an accounting system.

A general ledger represents the central books of a company, and every financial transaction flows through the general ledger. Typically, a corporate accounting system includes a number of subsidiary ledgers (sometimes referred to as sub-ledgers) for items such as cash, accounts receivable, accounts payable, and the like. All entries that are entered (posted) to the sub-ledgers transact through the general ledger accounts (via distribution lines). A distribution line is an entity that represents a detailed financial record for a transaction within the accounting system. A distribution line contains an account and a debit or credit amount (which can be zero). For example, when a customer sale is entered, which is posted in an accounts receivable sub-ledger, two or more distribution lines representative of the sale are posted to the general ledger. If the account on the distribution line is a statistical account, the distribution line can contain a quantity rather than an amount. A distribution line can also contain other attributes.

The general ledger provides an internal trail of transactions, so that any discrepancy (such as double-billing, unrecorded payments, and the like) can be readily identified and the origin can be traced in order to verify the accuracy of the accounting. Thus, it is important that companies keep their sub-ledgers in balance to their General Ledger.

Conventionally, users of financial management solutions often experience difficulty in keeping their General Ledger accounts in balance with the plurality of sub-ledgers. In many computer-based financial management systems, the general ledger controls or owns each distribution, even if the distribution originated from a sub-ledger. For example, when a user posts a customer invoice for $100, the customer balance is updated for $100. Additionally, the accounts receivable account should be updated for $100. In conventional systems, even if the accounts are updated correctly, an accounting administrator can make changes to general ledger entries without any requirement that the dollar values match the original entry. Conventionally, each distribution line is owned by the general ledger, meaning that distribution lines that have been posted to the general ledger can be changed without regard to the originating document, which can cause a discrepancy (in debit or credit amount, for example). Such discrepancies between the account balance in General Ledger and the sub-ledger balances can be extremely difficult to trace. Moreover, since the General Ledger typically owns the distribution lines, associations between the General Ledger distribution lines and the originating document on which the distribution lines are based can be lost. Consequently, it can be difficult for officers of a company to make business decisions based on such distribution lines, which have lost their association to the original document.

There is an on-going need in computerized financial accounting systems for improvements in maintaining balances between the various ledgers. Embodiments of the present invention provide solutions to these problems and provide advantages over conventional systems.

### SUMMARY OF THE INVENTION

A computer-based accounting system has sub-ledgers, a general ledger and centralized distributions. The sub-ledgers are adapted to record transaction information. The general ledger is adapted to record transaction information from general ledger transactions and information representative of the transaction information from each of the sub-ledgers. The centralized distributions is a repository of distribution lines corresponding to the transaction information contained in the general ledger and the sub-ledgers. The centralized distributions is adapted to associate each distribution line with an originating transaction, allowing the originating transaction to maintain control of its distribution lines.

In one embodiment, a distribution line manager is adapted to post the transaction information from each sub-ledger and from the general ledger to the centralized distributions. The distribution line manager is adapted to validate each distribution line against the originating transaction and its associated distribution lines.

### BRIEF DESCRIPTION OF THE DRAWINGS

FIG. 1 is a diagrammatic view of a computing system environment on which an embodiment of the present invention may be implemented.

FIG. 2 is a simplified block diagram of an accounting system according to an embodiment of the present invention.

FIG. 3 is an expanded block diagram of the accounting system with centralized distributions according to an embodiment of the present invention.

FIG. 4 is a simplified block diagram of a local service relative to the common distribution service library according to an embodiment of the present invention.

FIG. 5 is a simplified block diagram of a relationship between a transaction and a distribution line according to an embodiment of the present invention.

FIG. 6 is a simplified table representing information on an accounts receivable invoice according to an embodiment of the present invention.

FIG. 7 is a simplified table representing distribution lines in centralized distributions for the accounts receivable invoice information of FIG. 6 according to an embodiment of the present invention.

FIG. 8 is a simplified block diagram illustrating relationships between the invoice information and the distribution lines in a centralized distribution system according to an embodiment of the present invention.

FIG. 9 is a simplified flow diagram illustrating a process for creating a distribution line in central distributions according to an embodiment of the present invention.

FIG. 10 is a simplified block diagram of a computer-aided accounting system according to an embodiment of the present invention.

### DETAILED DESCRIPTION OF ILLUSTRATIVE EMBODIMENTS

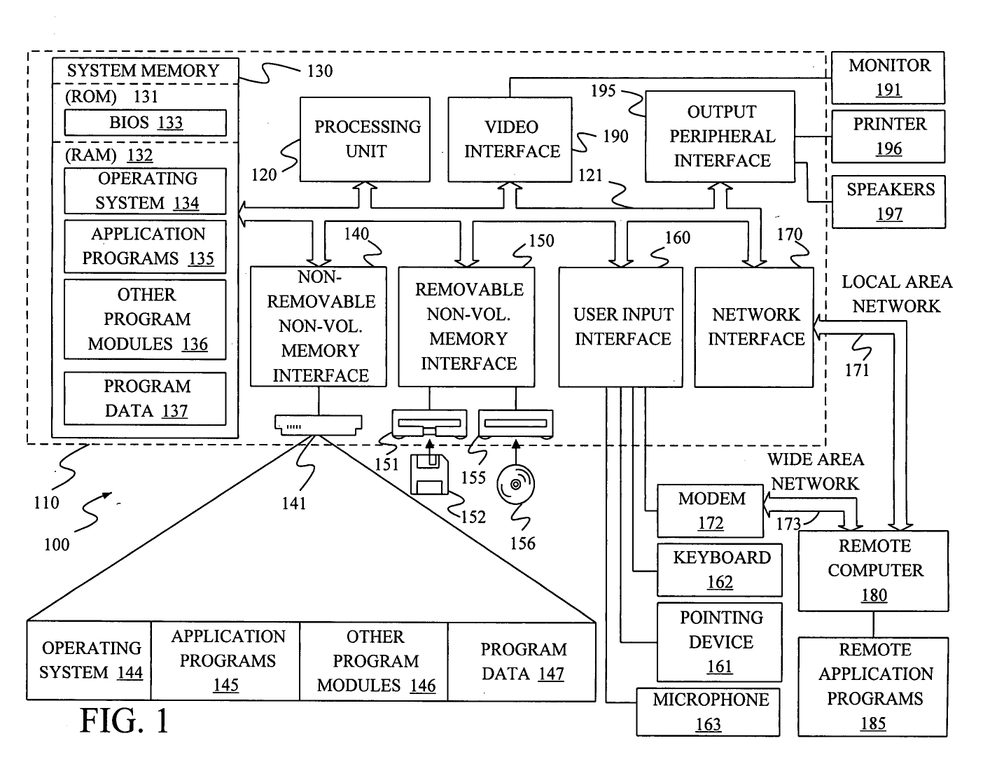

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, and the like, which perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. The phrase “computer storage media” is intended to include both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

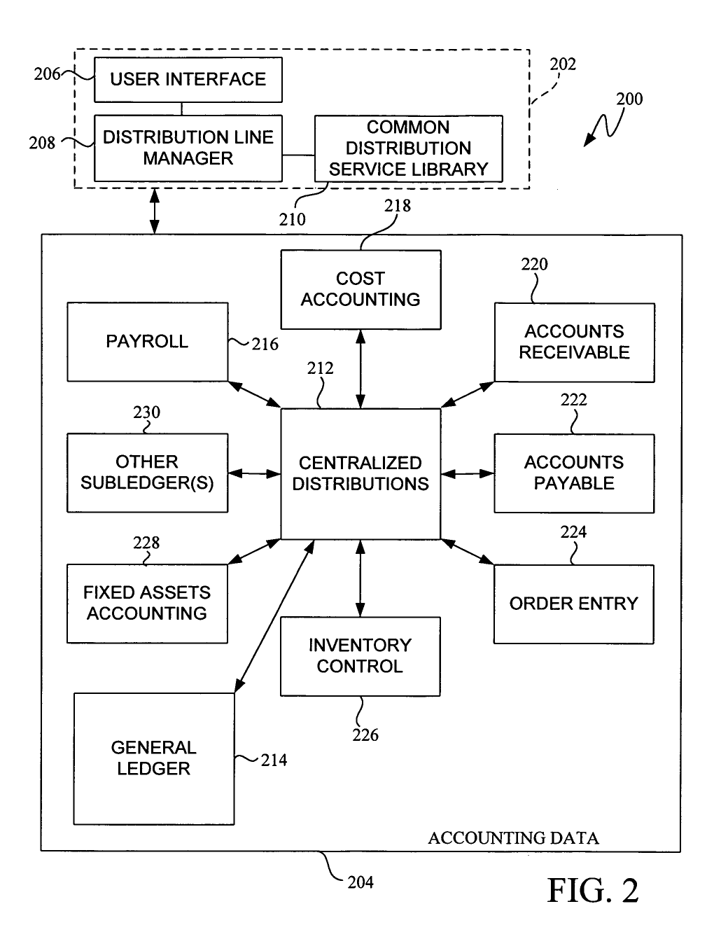

FIG. 2 is a simplified block diagram of an enterprise accounting system 200 according to an embodiment of the present invention. The accounting system 200 includes an accounting application 202 adapted to interact with accounting data 204. The accounting application 202 includes a graphical user interface 206, a distribution line manager 208, and a common distribution service library 210. The accounting data 204 is comprised of a plurality of data files. In one embodiment, the accounting data 204 includes a centralized distributions data file 212, which serves as a common repository for recording all distribution lines within the accounting system 200. Distribution lines are detailed financial records for transactions. Transactions typically represent their core data using transaction lines, which generally also have distribution lines that are posted in conjunction with the transaction line. Distribution lines represent the general ledger account information and the amount information.

The accounting data 204 can also include the data associated with various ledgers, including general ledger 214 and sub-ledgers (216-230). The general ledger 214 generally contains transaction information from the various sub-ledgers as well as transaction information from transactions originating from within the general ledger 214 (“general ledger transactions”). The sub-ledgers can include a payroll sub-ledger 216, a cost accounting sub-ledger 218, an accounts receivable sub-ledger 220, an accounts payable sub-ledger 222, an order entry sub-ledger 224, an inventory control sub-ledger 226, a fixed-assets accounting sub-ledger 228, and other sub-ledgers 230, depending on the specific implementation.

In general, the graphical user interface (GUI) 206 provides an operator interface for accessing various features of the accounting system 200, such as reporting features, utilities, and various other functions for interacting with the account data 206. Additionally, distribution lines can be accessed and/or edited by an operator via the GUI 206.

It should be understood that operations on distribution lines within the accounting system 200 are not performed in isolation. Editing a single distribution line typically impacts the transaction to which the single distribution line is associated. The distribution line manager 208 provides an interface for loading, validating and saving distribution lines and for creating new distribution lines in the context of a specific transaction. For example, if an amount in a transaction line is mapped to two new distributions, the distribution line manager 208 creates the distribution lines and validates that the amounts of the newly created distribution lines balance. Additionally, the distribution line manager 208 can be used to create distribution lines in a non-interactive mode for processes that execute without user (operator) intervention.

The distribution line manager 208 also provides several views (detailed, summary, and the like) of the distributions, from which the GUI 206 can retrieve distribution entities for display and editing purposes.

In general, each sub-ledger can be associated with its own service. For example, the payroll sub-ledger 216 can be associated with payroll services, which can be accessed via GUI 206. In one embodiment, the GUI 206 can be service-specific, meaning that the GUI 206 provides different options and different information according to the specific service and according to the user's access permissions. Thus, a manager of payroll services can have different GUI 206 views, which can display information that is different from or additional to information displayed in an associate in payroll services, for example.

In one embodiment, each service defines its own distribution line manager and its own distribution line entity by inheriting from a common distribution service library 210. Each service can then create and process its own distributions within its service boundaries, meaning that each service owns its own distributions. This allows services to enter transaction data and create distributions off-line. Additionally, by permitting each service to define its own distribution entity, the GUI 206 can provide an interface that is tightly coupled to the service. Finally, edits made to distributions in the local services are replicated to centralized distributions 212, through the distribution line manager 208.

The distribution line manager 208 is adapted to enforce various editing restrictions on distribution lines based on information contained in the distribution line header. Local instantiations of the distribution line manager 208 (service-specific distribution line managers, for example) are adapted to enforce replication rules and editing restrictions placed on each distribution line by inheritance from the local distribution entity. For posted distribution lines, the distribution line header defines editing restrictions for enforcement by the distribution line manager 208, allowing the posted header to control how distribution lines are processed within the system.

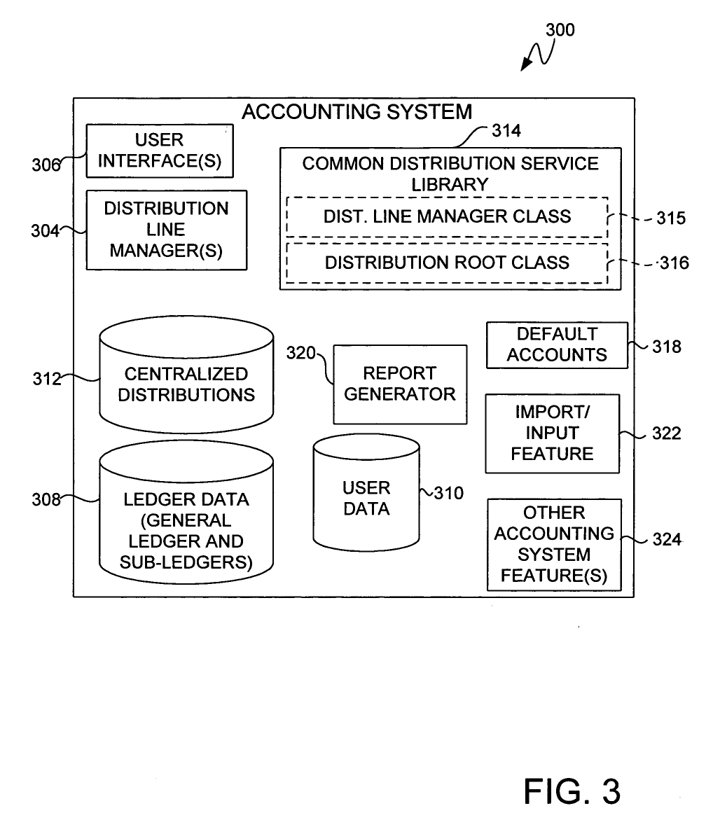

FIG. 3 is a simplified block diagram of an enterprise financial accounting system 300 with centralized distributions according to an embodiment of the present invention. The system 300 can be coupled to one or more businesses, subsidiaries or accounts, over a network, for example.

The system 300 includes one or more distribution line managers 304, a user interface 306, ledger data 308 (including a general ledger and sub-ledgers), user data 310, centralized distributions data 312, and a common distribution service library 314, which can include a distribution manager class 315 and a distribution root class 316. Additionally, the system 300 includes a default accounts feature 318 (or default account settings), a report generator 320, an import/export feature 322, and other accounting system features 324.

A user, such as an accountant, can access the data stored in the ledger data 308 by interacting with user interface 306. In one embodiment, the distribution manager 304 retrieves distribution lines for the particular ledger from the centralized distributions 312 and generates the display information for display in the user interface 306. Alternatively, the distribution manager 304 retrieves data from the requested ledger within ledger data 308, which may include distribution lines and/or distribution line header information, and displays the retrieved data in the user interface 306. The user can manipulate the displayed data according to rules defined in a distribution line header, which are enforced by the one or more distribution line managers 304.

The distribution line manager 304 is used by the sub-ledgers within the ledger data 308 for creation of new distribution lines and/or for division of existing distribution lines. Additionally, the distribution line manager 304 enforces rules and access permissions defined in a header of each distribution line. Finally, depending on the implementation, each service (such as accounts receivable, accounts payable, and the like) can have a service specific distribution line manager 304.

In one embodiment, the user interface 306 is a web-based interface accessible over a wide area network (such as the Internet), a local area network, or any other type of network. In another embodiment, the user interface 306 is provided by a stand-alone software application stored locally on a computer system and accessible by launching the software application.

The user data 310 can include user names, user passwords, and access privileges to the ledger data to control access to the system 300. For example, a manager may have read, write, edit and delete access to transaction records stored in the ledger data 308. An employee may have read only access to a limited subset of the data stored in the ledger data 308.

As used herein, the term “transaction line” refers to a line of financial information recorded in a sub-ledger. A distribution line is a record of the transaction within centralized distributions 312. Centralized distributions 312 is a repository of distribution lines, each of which can be associated with a transaction line or a header that represents a transaction within the system 300. While centralized distributions 312 is shown as a single data store, it should be understood that the centralized distributions 312 can be distributed over one or more servers, hard drives and the like, and/or can span multiple storage partitions, depending on the specific implementation.

Transaction headers (or their transaction lines) can be associated with more than one amount, which cause automatic creation of distribution lines by the one or more distribution line managers 304 within centralized distributions 312. In a preferred embodiment, a distribution line within centralized distributions 312 cannot be created without a header.

In general, the one or more distribution line managers 304 are adapted to update the centralized distributions 312 with one or more distribution lines for each currency amount associated with each transaction line created within a ledger and/or for each currency amount associated with a transaction header. Thus, an invoice with itemized amounts can be posted to the centralized distributions 312 by the distribution line manager 304 as separate distribution lines that share the same header. The centralized distributions 312 retains origination information about the transaction line based on the transaction header, which can be used to retain an association to the originating document and to validate new or edited distribution lines against the originating document. Consequently, even if a distribution line is changed in centralized distributions 312, the distribution line manager 304 can ensure that the amount of the distributions add up to the total amount of the originating document, thereby preventing unintentional imbalances in the ledger data 308.

The common distribution service library 314 includes root classes (315-316) that are shared by the various services associated with the system 300 (such as accounts receivable, inventory, accounts payable, and the like). The common distribution service library 314 includes a distribution line manager class 315 and a distribution root class 316, each of which define properties and attributes used across all services. For example, each service can have a distribution line manager 304 that inherits from the distribution line manager root class 315. In default accounts 318, the user defines which accounts and dimension code(s) to default for each distribution type. The distribution type is associated with a distribution line in centralized distributions 312 and is used to process default accounts and dimensions onto distribution lines by distribution line managers 304.

Generally, there is a link between each header and transaction line(s) in any of the ledgers and their associated distribution lines in centralized distributions 312. If a change is made to any given header/transaction line(s), the associated distribution lines in centralized distributions 312 are updated with the changes by the distribution line manager 304.

In one embodiment, upon creation of a distribution line, the distribution line manager 304 sends the distribution line to the centralized distributions 312 and causes a simulated general ledger header to be created in general ledger within ledger data 308. Distribution lines created by a sub-ledger, for example, can be viewed, edited, and so on by accessing the distribution lines through the simulated general ledger header. The simulated general ledger header provides a means for enforcing and validating transactions according to constraints placed on the distribution lines by the owner. For example, an accounts receivable invoice may not allow the transaction currency and the exchange rate to be modified on the distribution lines. Instead, the values must be edited on the original invoice header or transaction lines, which cause the distribution line manager 304 to update the distribution line in centralized distributions 312.

The simulated general ledger header allows a user to access the distribution lines for the sub-ledger transaction through the general ledger. However, since the simulated general ledger header represents the sub-ledger transaction header and its associations in centralized distributions 312, changes made to the distribution lines through the simulated header are managed by the distribution line manager 304, which validates and enforces constraints imposed by the originating document. Specifically, the simulated general ledger header can be conceptualized as a place holder that links to the actual header information. By selecting the simulated general ledger header, which is displayed like any other General Ledger transaction header, the user indirectly accesses the information in the centralized distributions 312, thereby triggering the distribution line manager 304 to validate any changes.

While the above discussion has focused on automatic creation of distribution lines, distribution lines can also be created manually, provided that the distribution line is associated to an existing header or transaction. In other words, distribution lines cannot be created within centralized distributions 312 without a transaction header or a transaction line (the transaction header or transaction line maintain the association to the originating document or owner). Generally, the distribution line can be created by accessing an existing transaction within a given ledger using the user interface 306. The user or operator accesses a given ledger via the interface 306, selects a transaction, and creates a new distribution line. The distribution line manager 304 generally performs the selected functions in a manner that is invisible to the user.

There may be different requirements placed on the newly created distribution lines according to the type of transaction represented by the distribution line. For example, when a distribution line is created manually on a general ledger transaction, the transaction currency and exchange rates can be modified directly on the distribution line. However, when a new distribution line is added to an accounts receivable invoice to split the sale between more than one general ledger account, the transaction currency and exchange rate default from the header of the original transaction and cannot be modified on the distribution lines.

The report generator 320 can be accessed by an operator using the user interface 306 or can be accessed directly to export or print reports based on the ledger data 308. The import/export feature 322 allows for the importation of transactions and their distribution line information, such as from a file, a portable device, and the like. The other accounting system features 324 can include administrative features, account creation and setup features, system diagnostic utilities, and various other accounting system features.

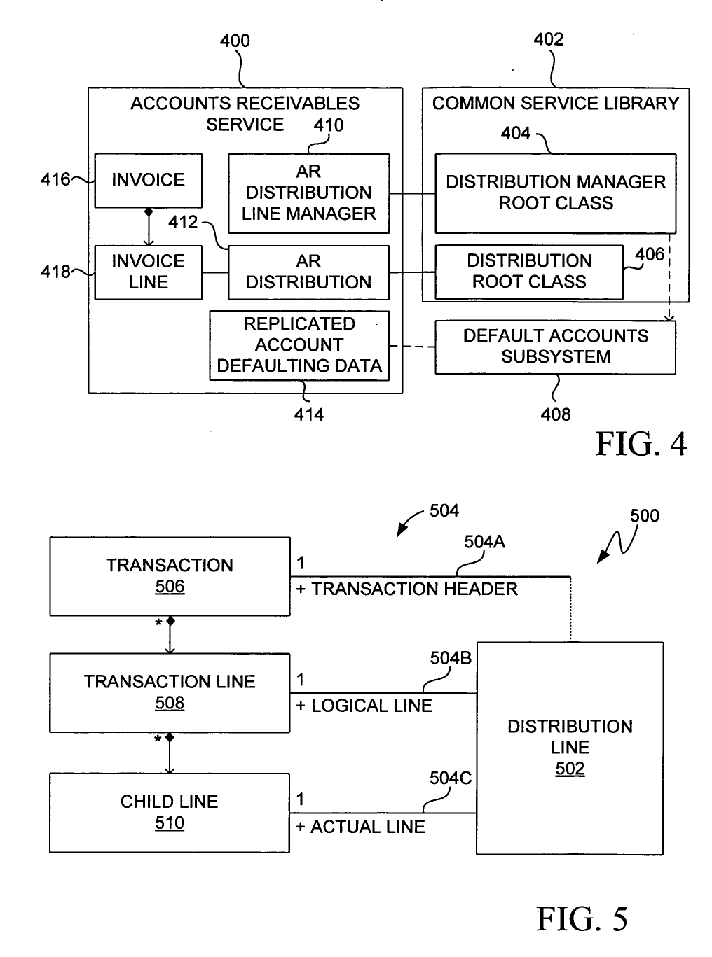

FIG. 4 is a simplified block diagram of a local service package, such as an accounts receivables (AR) service package 400, relative to the common distribution service library package 402 according to an embodiment of the present invention. The common distribution service library package 402 includes a distribution manager root class 404 and a distribution root class 406. The AR service package 400 includes an AR distribution manager 410, an AR distribution entity 412, and Replicated Account Defaulting Data 414. The common distribution service library package 402 and the AR service package 400 also work with the default accounts subsystem 408.

The distribution manager root class 404 provides the core functionality for the AR distribution manager 410. Thus, the AR service package 400 defines its own distribution line manager by deriving from the abstract distribution manager root class 404. Similarly, the distribution root class 406 provides the common properties and attributes that define the distribution entity, which is used to represent each distribution line within the accounting system. The AR distribution entity 412 is a specialized class derived from the distribution root class 406. The Replicated Account Defaulting Data 414 denotes that replicated data is stored on the AR service package 400 for the default accounting sub-system 408, whose data is mastered in a common service, for example General Ledger.

An invoice 416 is entered into the AR service 400 via an AR GUI. The invoice 416 is typically composed of at least one invoice line 418, which is associated to the AR distribution entity 412, which derives from the distribution root class 406 of the common distribution services library package 402.

FIG. 5 is a simplified block diagram of a relationship between a transaction 500 and a distribution line 502 according to an embodiment of the present invention. There is a set of associations 504 from a distribution line 502 to the transaction 500.

Each transaction 500 can include a transaction entity 506, composed of one or more transaction lines 508, which are in turn composed of one or more transaction child lines 510. The associated distribution line 502 can have multiple owners, corresponding to the transaction entity 506, the associated transaction lines 508, and the associated transaction child lines 510. The transaction entity 506 is associated to the distribution line 502 by a transaction header key 504A. The transaction line 508 is associated to the distribution line 502 by a logical line key 504B. The transaction child line 510 is associated to the distribution line 502 by an actual line key 504C.

Transaction lines 508 can have transaction child lines 510, and transaction child lines 510 can have transaction child lines 510. The transaction entity 506 can have transaction lines 508 of multiple entity types, and so on. The tree representing transaction 500 can be arbitrarily complex with some lines modeled as compositions and other lines modeled as associations.

Centralized distributions stores a distribution line that corresponds to three parts of the transaction 500 hierarchy: the transaction header 504A, the logical line 504B, and the actual line 504C. Centralized distributions does not necessarily know the precise relationship between the logical and actual lines. The transaction header key, the logical line key, and the actual line key model the associations.

In general, a distribution line can be attached directly to a header of the transaction. This is necessary for transactions that do not have transaction lines. Additionally, there are instances where distribution lines may be directly related to the header and not to any of its transaction lines. All three associations simply point to the transaction header 506, and the header 506 acts as both the logical transaction line (transaction line 508) and the actual transaction line (child line 510).

In general, the primary owner of a distribution line is the logical transaction line, which is represented by the logical line key 504B. The secondary owners of a distribution line are the transaction header 506 and the actual transaction line 508, represented by the transaction header key 504A and the actual line key 504C. The association to the logical transaction line (represented by logical line key 504B) is considered primary because the distribution line is more intimately connected to it with respect to the distribution manager. Specifically, the distribution manager uses the logical transaction line to manage distribution lines and to retrieve distribution line information. The secondary owner links have uses as well. For example, the actual line key 504C is used in conjunction with displaying the transaction line number on distribution lines.

From a perspective of the logical line 504B, each distribution line is identified primarily by the distribution type. But the actual line key 504C is often necessary to complete a distribution line selection. For inter-company distribution lines, a group index may also be necessary. One additional selection parameter is the field index.

Transaction lines with fees typically model the fees as child lines (such as child line 510). In that model, the distribution type and actual line key 504C are sufficient (usually) to differentiate all of the distribution line amounts. When there is only a logical line (represented by logical line key 504B) that holds a fixed number of fee amounts with each fee using the same distribution type, the field index is used to complete the selection criteria with the field index playing a role similar to the actual line key 504C. Thus, the field index is necessary whenever an actual line defines multiple distribution lines that use the same distribution type.

A distribution line for a field amount is identified by a distribution type, and actual line key 504C, a group index, and a field index. If a field amount is split into several distribution lines with different accounts, the field index may describe a set of distribution lines.

In the simplest case of line distributions, one field amount is mapped into two distribution lines. For example, the amount is mapped into one distribution line with a distribution type of sales and into another distribution line with a distribution type of accounts receivable. The field amount is the same for both distribution lines, but each distribution line can have a different balance type (such as credit or debit) so that the distribution lines balance.

Each transaction line specifies a set of tuples comprised of the following values: distribution type, actual line key 504C, group index, field index, transaction amount, and balance type. This information is used by the distribution manager when creating distribution lines and when validating amounts.

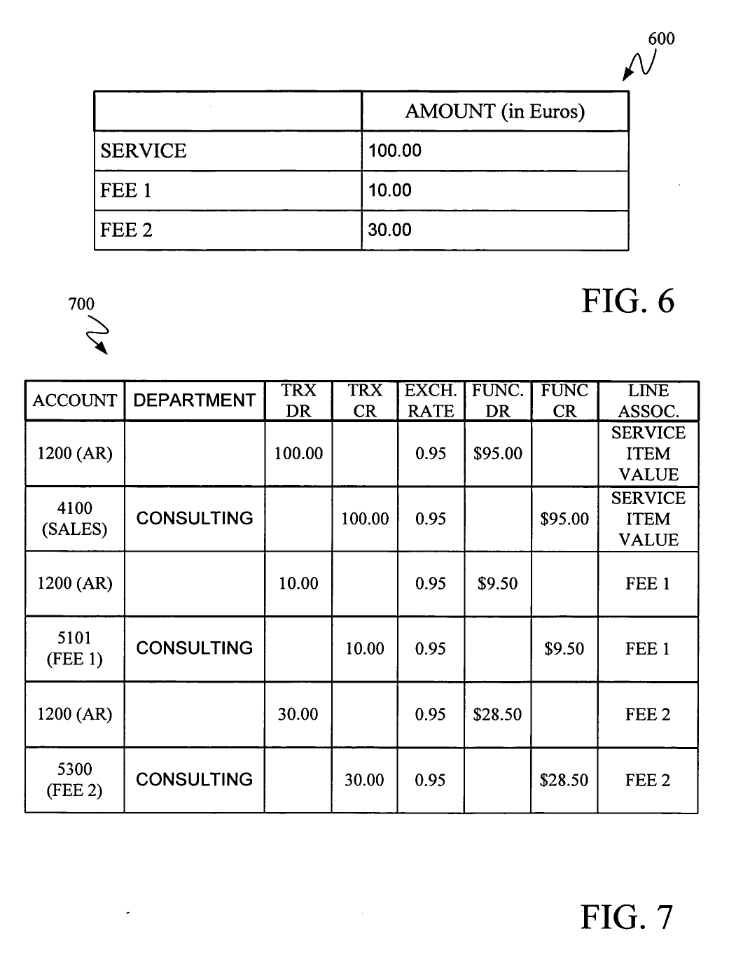

FIG. 6 is a simplified table 600 illustrating information from a single accounts receivable invoice. In this invoice, the amounts are listed in Euros. The table 600 shows itemized invoice amounts of one hundred Euros for service, ten Euros for fee one, and 30 Euros for fee two.

FIG. 7 illustrates a simplified table 700 of distribution lines within centralized distributions corresponding to the invoice values in FIG. 6, for example, according to an embodiment of the present invention. In this instance, the accounts receivable account number is “1200 (AR)”, reflecting a debit of $95.00. According to a default account setting or based on a manual creation of a distribution line, a second distribution line associated with the service item value is created for account “4100 (Sales)” with an Euro to dollar exchange rate of 0.95. Separate distribution lines are also created for Fee 1 and Fee 2, which are debited and credited the respective fee values.

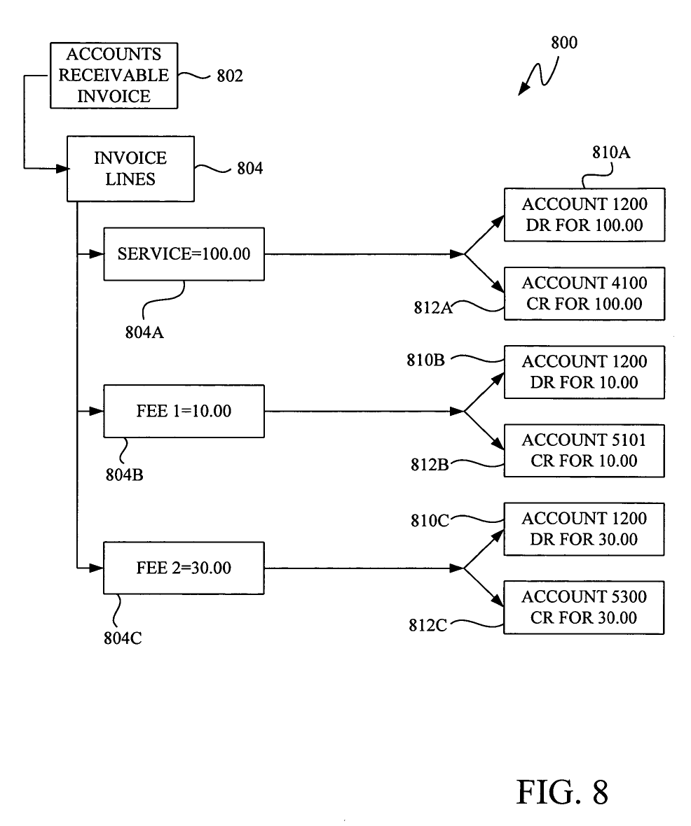

FIG. 8 is a simplified block diagram 800 illustrating relationships between an invoice, items on the invoice and the various distribution lines according to an embodiment of the present invention. The diagram 800 has an invoice 802 (the transaction header) containing invoice lines 804 (the transaction lines), which are itemized as line 804A (service=100.00 Euros), line 804B (Fee 1=10.00 Euros), and line 804C (Fee 2=30.00 Euros). Each line 804A-804C can be associated with one or more distribution lines, such as distribution lines 810A-810C and 812A-812C. For example, the service line 804A is associated with the accounts receivable (1200) distribution line 810A and the credit distribution line 812A, which represent distribution lines to particular General Ledger accounts. Similarly the fee transaction line 804B is associated with another accounts receivable (1200) distribution line 810B and a credit to account 5101 on distribution line 812B. The invoice line 804C is similarly associated with another accounts receivable (1200) distribution line 810C and credit distribution line 812C.

In each instance, the distribution lines 810A-810C and 812A-812C represent distributions associated with an original transaction record in centralized distributions containing information about the transaction and its associations. All of the distribution lines 810 and 812 maintain an association to the originating document, thereby allowing sub-ledgers to retain ownership over their distribution lines, even if the distribution lines are posted to centralized distributions. The originating document or source for a given transaction retains ownership over the transaction, even within the general ledger. Consequently, changes to an amount and other attributes can be made on the originating invoice or on the distribution line, but the total must match the total on the transaction header/line to which it is associated. If the amounts do not match, an error can be placed on the distribution line, which must be fixed before the system will allow the invoice and distribution lines to be posted.

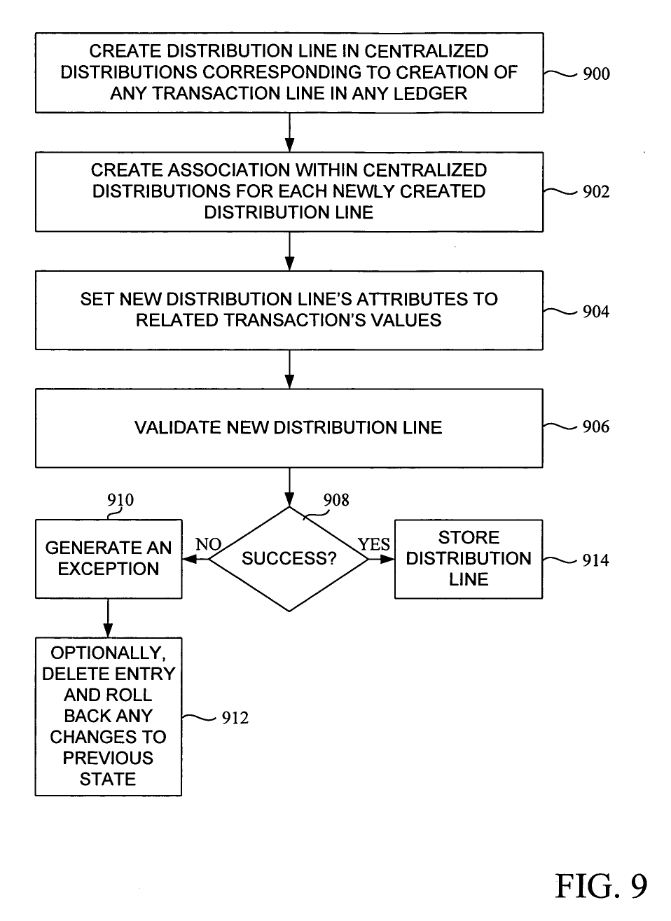

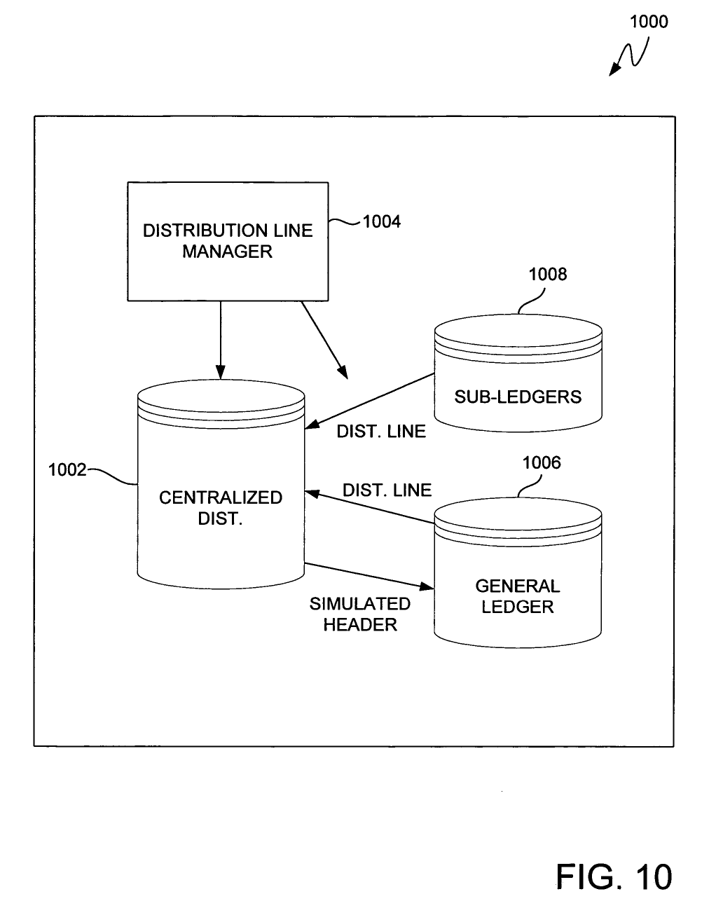

FIG. 9 is a simplified flow diagram of a process for maintaining a repository of centralized distributions according to an embodiment of the present invention. A distribution line is created in central distributions corresponding to the creation of any transaction line of any ledger associated with the accounting system (step 900). An association is created with centralized distributions for each newly created distribution line relative to its originating document (step 902). The new distribution line's attributes are set to transaction values of related transaction (step 904). The system then validates the new distribution line (step 906). If the validation process does not succeed (step 908), the system generates an exception or error (step 910). Optionally, the system can delete the entry and roll back any changes to a previous state (step 912). Alternatively, the system can identify the error and return the error information to the user for correction. If the validation process succeeds (step 908), the distribution line is stored or added to centralized distributions (step 914).

In general, centralized distributions is a repository of distribution lines for maintaining associations between the distribution line and the original document or source for the transaction. Changes or modifications to an existing distribution line can be made by modifying the originating document, which may update the distribution lines. Alternatively, changes to a distribution line can be made via a simulated general ledger header in the general ledger, provided the amount of the distribution line matches the amount in the originating document. The distribution line manager is adapted to ensure that such changes add up, and to protect against changes that do not balance. Additionally, allocations based on a transaction line value that is less than the value of the transaction line can result in two distribution lines, one for the allocation and one for the unallocated portion of the transaction line value. For example, in one instance, if the transaction is for $100 and only $80 exists on the distribution line, there may be another distribution line for the remaining $20. Alternatively, if there is no second distribution line, the transaction can be entered and an error is flagged. The distribution line manager then requires the error to be corrected (such that the distribution line(s) balance to $100) before the invoice can be posted, for example to the centralized distributions. In such instances, the original distribution amount remains unchanged.

It should be understood that centralized distributions represents transaction information from all ledgers of a business accounting system. Centralized distributions is not part of the general ledger, or of any other sub-ledger, but rather is a repository of distribution lines that represent distribution lines from the general ledger and the one or more sub-ledgers.

FIG. 10 is a simplified block diagram of an accounting system 1000 having a centralized distributions 1002 and a distribution line manager 1004 according to an embodiment of the present invention. The system 1000 includes a general ledger 1006 and a plurality of sub-ledgers 1008. Each transaction posted through any of the sub-ledgers 1008 or through the general ledger 1006 are recorded in centralized distributions 1002 by the distribution line manager 1004. Upon posting of each transaction from a sub-ledger to centralized distributions 1002, the distribution line manager 1004 creates a simulated general ledger header in the general ledger 1006. The simulated general ledger header is associated with the distribution line data stored in centralized distributions 1002. An operator can view, edit, and otherwise interact with the data stored in the centralized distributions 1002 through the simulated general ledger header in the general ledger 1006, without having to replicate the data to the general ledger 1006. In this manner, not only is memory conserved, but the distribution line manager 1004 can enforce constraints and validate distribution lines posted to the centralized distributions.

In one embodiment, non-general ledger transactions (such as any transaction owned by a sub-ledger, for example) are posted to the centralized distributions by the distribution line manager. Upon posting of the distribution lines to centralized distributions, the distribution line manager also creates a simulated general ledger header in the general ledger. The simulated general ledger header contains a source type, source attribute, and other information pertaining to the originating transaction. The source attribute on the simulated general ledger header is updated with an identifier of the distribution line's owner, which may be a unique serial number automatically generated for each distribution line in centralized distributions.

For example, when an AR invoice is posted, a simulated general ledger header is created for the distribution lines. The simulated general ledger header allows the user to select, view, edit and post the distribution lines associated with the simulated header from the general ledger as if it were a general ledger transaction, instead of having to post the distributions through the originating AR invoice. If an error exists on a distribution line created from an AR invoice, for example, the simulated header allows the user to correct the distribution lines only, rather than correcting the AR invoice. Specifically, the user can select the distribution line to be corrected through the simulated header, which represents the distribution line.

The distribution lines assigned to a simulated general ledger header are still owned by their originating transaction, and not by the simulated general ledger header. This means that the distribution validation required by the owner must still be satisfied before the distribution lines can be posted. Moreover, validation must be satisfied in order to correct the distribution lines after the simulated header is posted.

Although the present invention has been described with reference to particular embodiments, workers skilled in the art will recognize that changes may be made in form and detail without departing from the spirit and scope of the invention.

What is claimed is:

1. A computer-based accounting system comprising:
sub-ledgers adapted to record transaction information;
a general ledger adapted to record transaction information from general ledger transactions and information representative of the transaction information from each of the sub-ledgers; and
centralized distributions comprising a repository of distribution lines corresponding to the transaction information contained in the general ledger and the sub-ledgers, the centralized distributions adapted to associate each distribution line with an originating transaction, allowing the originating transaction to maintain control of its distribution lines.

2. The computer-based accounting system of claim 1 wherein the transaction information from the sub-ledgers is recorded in the general ledger using a simulated general ledger header representative of a transaction header associated with the originating transaction.

3. The computer-based accounting system of claim 1 further comprising:
a distribution line manager adapted to store the transaction information from each sub-ledger and from the general ledger in the centralized distributions, the distribution line manager adapted to validate each distribution line against the originating transaction and its associated distributions.

4. The computer-based accounting system of claim 3 wherein the distribution line manager is adapted to generate simulated general ledger headers containing information representative of the transaction information for each sub-ledger and to store each simulated general ledger header in the general ledger.

5. The computer-based accounting system of claim 4 further comprising:
a user interface adapted to provide user access to the distribution lines, wherein distribution lines associated with an originating transaction are accessible through the simulated general ledger headers or through general ledger headers.

6. The computer-based accounting system of claim 1 wherein each distribution line comprises:
an identifier defining an association to the originating transaction; and
attributes associated with a header of the originating transaction.

7. A financial accounting system comprising:
ledgers for storing transaction information, the ledgers comprising a general ledger and a plurality of sub-ledgers;
a centralized distributions data file containing a plurality of distribution lines, each distribution line associated with a financial transaction stored in one or more of the ledgers; and
a distribution line manager coupled to the ledgers and to the centralized distributions, the distribution line manager adapted to store distribution lines from each ledger to the centralized distributions data file upon creation.

8. The financial accounting system of claim 7 further comprising:
a user interface coupled to the ledgers and adapted to allow operator interaction with the stored transaction information.

9. The financial accounting system of claim 7 wherein the distribution line manager is adapted to modify and validate distribution lines based on the originating document.

10. The financial accounting system of claim 7 wherein each financial transaction corresponds to an originating document and wherein each new distribution line is associated with a currency amount from the originating document.

11. The financial accounting system of claim 7 further comprising:
a common distribution service library comprising a plurality of root classes shared by services associated with the financial accounting system.

12. The financial accounting system of claim 11 wherein the plurality of root classes comprises a distribution line manager root class and a distribution line root class.

13. The financial accounting system of claim 7 wherein each distribution line comprises:
an identifier defining an association to a transaction line corresponding to transaction information; and
attributes associated with a transaction header, with one or more transaction lines associated with the header, or with one or more child lines of a transaction line.

14. A computer-aided accounting system comprising:
ledgers for storing financial transactions, the ledgers comprising a general ledger and a plurality of sub-ledgers; and
a repository of distribution lines, each distribution line associated with a financial transaction of the ledgers and adapted to maintain the association of the distribution lines with the originating document.

15. The computer-aided accounting system of claim 14 wherein the repository establishes ownership of each distribution line to the associated financial transaction by assigning an association.

16. The computer-aided accounting system of claim 14 further comprising:
a distribution line manager adapted to create and edit one or more distribution lines within the repository for each financial transaction in the ledgers.

17. The computer-aided accounting system of claim 16 wherein the distribution line manager is adapted to validate distribution lines before posting the distribution lines to the repository.

18. The computer-aided accounting system of claim 16 wherein the distribution line manager is adapted to generate a simulated general ledger header representative of transaction information from a sub-ledger of the plurality of sub-ledgers and to store the generated simulated general ledger header in the general ledger.

19. The computer-aided accounting system of claim 14 further comprising:
a common distribution service library comprising a plurality of root classes shared by services associated with the financial accounting system.

20. The computer-aided accounting system of claim 14 further comprising:
a user interface coupled to the ledgers and adapted to allow operator interaction with the stored transaction information.
